(19) United States
(12) Patent Application Publication
(10) Pub. No.: US 2020/0279147 A1
(43) Pub. Date: Sep. 3, 2020

(54) METHOD AND APPARATUS FOR INTELLIGENTLY RECOMMENDING OBJECT

(71) Applicant: BAIDU ONLINE NETWORK TECHNOLOGY (BEIJING) CO., LTD., Beijing (CN)

(72) Inventors: Yuan XIA, Beijing (CN); Jun CHEN, Beijing (CN); Zhenhui SHI, Beijing (CN); Chao LU, Beijing (CN); Haifeng HUANG, Beijing (CN)

(21) Appl. No.: 16/802,331

(22) Filed: Feb. 26, 2020

(30) Foreign Application Priority Data
Feb. 28, 2019 (CN) 201910149015.7

(51) Int. Cl. G06N 3/04; G06F 40/30; G06F 40/295

(52) U.S. Cl. CPC G06N 3/0427; G06N 3/0445; G06F 40/295; G06F 40/30

(57) ABSTRACT

Embodiments of the present disclosure provide a method and an apparatus for intelligently recommending an object, a device and a storage medium. The method includes: generating a user feature representation based on description information of a user request and a candidate object feature representation based on expertise information of a candidate object; determining a responsivity of the candidate object to the user based on the user feature representation and the candidate object feature representation; and selecting a target object for the user from candidate objects according to responsivities of the candidate objects to the user.

### CROSS REFERENCE TO RELATED APPLICATIONS

This application claims priority and benefit of Chinese Application No. 201910149015.7, filed on Feb. 28, 2019, the entire content of which is incorporated herein by reference.

### FIELD

Embodiments of the present disclosure relate to the field of internet technology, and more particularly to a method and an apparatus for intelligently recommending an object, a device, and a storage medium.

### BACKGROUND

With the development of big data and artificial intelligence, more and more companies and research institutions begin to study internet information recommendation.

Two kinds of methods exist for recommending an object intelligently. One is to establish an object index list based on representation information and entities according to a conventional rule tree and a conventional rule index, to perform object recommendation. The other is to recommend based on machine learning. The above is an object recommendation based on collaborative filtering and a method of ranking based on learning.

### SUMMARY

Embodiments of the present disclosure provide a method for intelligently recommending an object. The method includes: generating a user feature representation based on description information of a user request and a candidate object feature representation based on expertise information of a candidate object; determining a responsivity of the candidate object to the user based on the user feature representation and the candidate object feature representation; and selecting a target object for the user from candidate objects based on responsivities of the candidate objects to the user.

Embodiments of the present disclosure provide a device. The device includes: one or more processors and a storage device. The storage device is configured to store one or more programs. When the one or more programs are executed by the one or more processors, the method for intelligently recommending an object according to any one of embodiments of the present disclosure is implemented by the one or more processors.

Embodiments of the present disclosure provide a computer readable storage medium having a computer program stored thereon. The method for intelligently recommending an object according to any one of embodiments of the present disclosure is implemented when the computer program is executed by a processor.

### BRIEF DESCRIPTION OF THE DRAWINGS

For describing the technical solution of embodiments of the present disclosure more clearly, the accompanying drawings requiring to be used in the embodiments are briefly introduced below. It should be understood that, the following accompanying drawings merely illustrate some embodiments of the present disclosure, and should not be construed as limiting the scope. For the skilled in the art, other related accompanying drawings may be obtained based on these accompanying drawings without creative efforts

FIG. 1 is a flow chart illustrating a method for intelligently recommending an object according to embodiments of the present disclosure.

FIG. 2 is a flow chart illustrating a method for intelligently recommending an object according to embodiments of the present disclosure.

FIG. 3 is a block diagram illustrating an apparatus for intelligently recommending an object according to embodiments of the present disclosure.

FIG. 4 is a block diagram illustrating a device according to embodiments of the present disclosure.

### DETAILED DESCRIPTION

Detailed description will be further made below to embodiments of the present disclosure with reference to the accompanying drawings and the embodiments. It should be understood that, detailed embodiments described herein are intended only to explain the present disclosure, and are not intended to limit the present disclosure. In addition, it should be further noted that, for the convenience of description, only some contents but not all of the structure related to the present disclosure are illustrated in the accompanying drawings.

At present, most intelligent recommendation products are only capable of providing information of agencies of recommendation, but not recommending the objects, which often causes confusion to a user. Even though the user knows the agency based on the above products, it is unable to find a most matched object.

There are two kinds of methods for recommending an object intelligently. However, the conventional methods have following common disadvantages. 1) Each user is in different states and has different representations at different times. Such “interest deviation” exists objectively in some recommendation fields, and has a greater impact than that in a field of item recommendation. 2) It needs to train millions of parameters for the learning model. Therefore, a large number of sample tags is needed for the learning model. However, in some recommendation fields, there is often less high-quality tag data. 3) The accuracy and stability are not high.

Therefore, the present disclosure provides a method and an apparatus for intelligently recommending an object, a device and a storage medium, which may achieve a high accuracy of object recommendation, reduce a large number of parameters, and ensure high algorithm effectiveness.

With the present disclosure, the user feature representation based on the description information of the user request and the candidate object feature representation based on the expertise information of the candidate object are generated, the responsivity of the candidate object to the user is determined based on the user feature representation and the candidate object feature representation; and the target object is selected to the user from candidate objects based on responsivities of the candidate objects to the user, thereby realizing to recommend the target object to the user based on the description information of the user request. Since the description information of the user request may describe the current state of the user directly and accurately, performing the object recommendation based on the description information of the user request has high accuracy and high stability without depending on a large number of sample tags.

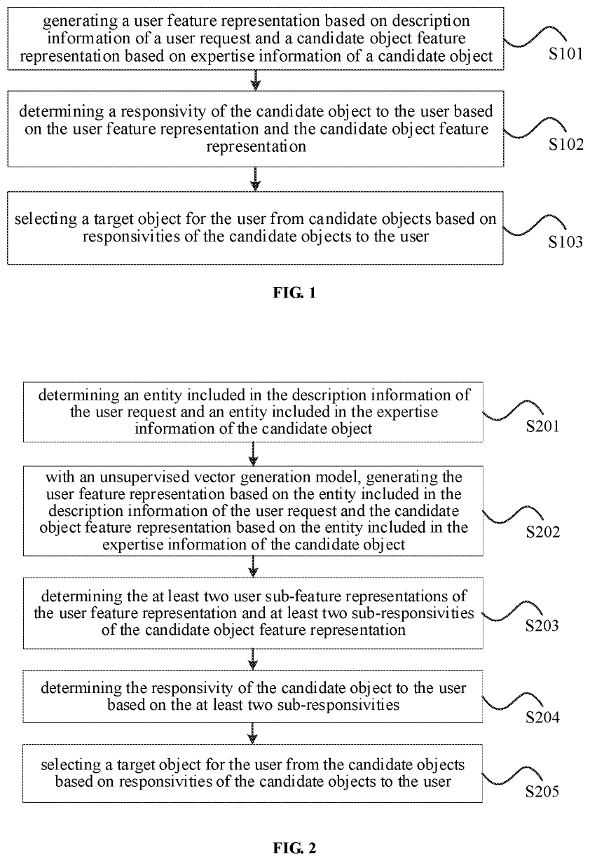

FIG. 1 is a flow chart illustrating a method for intelligently recommending an object according to embodiments of the present disclosure. Embodiments of the present disclosure may be applied to a scenario where the recommendation object is obtained through an application by a user. The method may be executed by an apparatus for intelligently recommending an object according to embodiments of the present disclosure. The method may include the following.

At block S101, a user feature representation and a candidate object feature representation are generated respectively based on description information of a user request and expertise information of a candidate object.

The description information of the user request may include a summary of descriptions on the user. The expertise information of the candidate object may include a summary of descriptions on expertise fields of the candidate object. In different scenes, the description information of the user request is different, and the corresponding expertise information of the candidate object is also different. For example, in a case where a graduate seeks a job, the description information of the user request may include education background, skills, expected salary and the like. The expertise information of the candidate object may include a scope of education background, expertise areas and salary ranges of positions of a candidate company. In a case where a patient desires to seek medical treatment, the description information of the user request may include descriptions of his/her symptom, a subjectively predicted disease and the like. The expertise information of the candidate object may include diseases that doctors are good at.

The user feature representation and the candidate object feature representation may be respectively digital feature representations of the description information of the user request and the expertise information of the candidate object. In an example, vectors may be used as the feature representation of the description information of the user request and the feature representation of the expertise information of the candidate object. The description information of the user request and the expertise information of the candidate object may be inputted to a trained vector generation model to obtain a vector representation of the description information of the user request and a vector representation of the expertise information of the candidate object.

Based on the obtained description information of the user request and the expertise information of the candidate object, the user feature representation and the candidate object feature representation are generated respectively, thereby realizing to directly and accurately characterizing the description information of the user request for describing current states of the user and the expertise information of the candidate object, which provides data basis for subsequently recommending a target object to the user.

At block S102, a responsivity of the candidate object to the user is determined based on the user feature representation and the candidate object feature representation.

The responsivity refers to a similarity or a matching degree. A high responsivity of the candidate object to the user may indicate a high similarity or a high matching degree between the candidate object and the user. A low responsivity of the candidate object to the user may indicate a low similarity or a low matching degree between the candidate object and the user.

In detail, the user feature representation and the candidate object feature representation may be considered as two groups of multi-dimensional input signals, which may be inputted to a mode response system including a response function. In an example, the response function may include, but not limited to, a cosine distance, a Euclidean distance, a convolution function, a Markov distance, a metric function based on a neural network, and the like. The mode response system may include one kind of response functions, multiple kinds of response functions or a linear combination of the multiple kinds of response functions. The responsivity of the candidate object to the user may be outputted by the mode response system.

At block S103, a target object is selected for the user from candidate objects based on responsivities of the candidate objects to the user.

In detail, responsivities of candidate objects to the user outputted by the mode response system may be ranked to obtain the at least one target object. The at least one target object is recommended to the user. The user may select one or more based on the at least one target object. In an example, to ensure accuracy for recommending the target object, a target object having the responsivity less than a preset threshold may be filtered out based on the preset threshold.

With the technical solution according to embodiments, the user feature representation and the candidate object feature representation are generated respectively based on the description information of the user request and the expertise information of the candidate object. The responsivity of the candidate object to the user is determined based on the user feature representation and the candidate object feature representation. The target object is selected for the user from the candidate object based on the responsivity of the candidate object to the user. Therefore, the target object may be recommended to the user based on the description information of the user request. Since the description information of the user request may directly and accurately describe the current state of the user, the object recommendation based on the description information of the user request may have high accuracy and high stability, without depending on a large number of sample tags.

FIG. 2 is a flow chart illustrating a method for intelligently recommending an object according to embodiments of the present disclosure. A detailed implementation is provided for embodiments of the present disclosure. The method may be executed by an apparatus for intelligently recommending an object according to embodiments of the present disclosure. The method may include the following.

At block S201, an entity included in the description information of the user request and an entity included in the expertise information of the candidate object are determined respectively.

The entity may refer to an object or a thing that objectively exists in the real world and may be distinguished from each other, such as a person, an animal, a plant, and a building.

In a case where a graduate seeks a job, following entities may be included and the entities are not limited thereto: education background, majors, certificates and the like. In a case where a patient seeks medical treatment, following entities may be included and the entities are not limited thereto: symptoms, diseases, inspections, tests, surgeries, medicines, and the like.

In an example, the block S201 may include the following.

A. Word segmentation is performed on the description information of the user request and the expertise information of the candidate object respectively according to entities included in a knowledge graph of a field where the candidate object belongs.

The knowledge graph may be obtained by performing entity marking on a large amount of professional terms in the field via professionals. The word segmentation refers to segmenting a word sequence (such as a sequence of Chinese characters) into individual words. For example, the method of the word segmentation may include a forward maximum matching method, a reverse maximum matching method, a minimum segmentation method, a two-way maximum matching method, and the like. The word segmentation is performed respectively on the description information of the user request and the expertise information of the candidate object based on the knowledge graph in the field, to distinguish the entities of this field from entities of other fields and different part-of-speech entities.

For example, the description information of the user request may be “I have a cough, a headache, and a stomachache today, and did I get a cold?”, and resultant word segments based on the knowledge graph of a medical field may be “I/have/a cough/a headache/a stomachache/today/did I/get/a cold/”. Expertise information of candidate object may be “I am good at treating colds and fevers”, and resultant word segments based on the knowledge graph of the medical field may be “I/am good at/treating/colds/and fevers”.

B. Resultant word segments of the description information of the user request and the expertise information of the candidate object are inputted to a depth learning network model, to obtain the entity included in the description information of the user request and the entity included in the expertise information of the candidate object.

The depth learning network model is to combine low-level features to form more abstract high-level representation attribute categories or features, to find distributed feature representations of data.

In detail, in embodiments, the depth learning network model is an entity recognition model, which may include a bidirectional long short-term memory network layer, an attention mechanism layer, and a conditional random field layer.

The bidirectional long short-term memory network layer is used to predict a probability that a target entity belongs to a preset tag based on context information of the target entity. For example, the preset tag may include “symptom”, “disease”, “exam”, “test”, “surgery”, and “medicine”. The resultant word segments of the description information of the user request, i.e., “I/have/a cough/a headache/a stomachache/today/did I/get/a cold/”, may be inputted to the bidirectional long short-term memory network layer. The probability that each entity belongs to the preset tag may be outputted. For example, the probability of “cough” belonging to “symptom” is about 0.7, the probability of “cough” belonging to “disease” is about 0.6, and the probability of “cough” belonging to “medicine” is about 0.1.

The attention mechanism layer may be used to automatically learn a weight for each word segment of the description information of the user request after the word segmentation. For example, the resultant word segments of the description information of the user request after the word segmentation is “I/have/a cold/today”. Based on actual needs, a weight may be determined for each word segments. For example, the weight of “I” may be about 0.1, the weight of “have” may be about 0.05, the weight of “a cold” may be about 0.65, and the weight of “today” may be about 0.2. The attention mechanism layer functions as assistance and judgment of the bidirectional long short-term memory network layer.

The conditional random field layer is used to obtain information outputted by the bidirectional long short term memory network layer. In addition, the conditional random field layer is used to determine a preset tag with a highest probability as the tag of the entity. Furthermore, the conditional random field layer is used to output a sentence that is in line with a natural language processing rule based on a ranking among word segments of the sentence after completing to recognizing the entities. For example, the conditional random field layer may output: “I/have/a cough [symptom]/a headache [symptom]/a stomachache [symptom]/today/did I/get/a cold [disease]”.

By inputting the description information of the user request and the expertise information of the candidate object to the depth learning network model including the bidirectional long short term memory network layer, the attention mechanism layer and the conditional random field layer, the word segments in the field and the entity recognition may be accurate.

At block S202, based on an unsupervised vector generation model, the user feature representation is generated based on the entity included in the description information of the user request and the candidate object feature representation is generated based on the entity included in the expertise information of the candidate object.

For example, literatures belonging to the field of the candidate object may be used as a corpus, to construct the unsupervised vector generation model. In a case where the field of the candidate object is a medical field, medical books, medical literatures, medical reports, medical dictionaries and the like compiled by medical experts may be used as the corpus, to construct the unsupervised vector generation model. For example, the unsupervised vector generation model may include a word2vec model, a Glove model, and a fasttext model. Based on the unsupervised vector generation model, entities generated by the natural language processing may be processed as distributed semantic representations, such as vectors.

In an example, based on the unsupervised vector generation model, at least two user sub-feature representations may be generated based on at least two entities included in the description information of the user request as the user feature representation. For example, the word2vec model may be employed as the unsupervised vector generation model, and the description information of the user request includes two entities, such as “symptom” and “disease”. Vectors [0.2, 0.5] and [0.3, 0.7] generated by the word2vec model may be the user feature representation.

In an example, based on the unsupervised vector generation model, at least two object sub-feature representations may be generated based on at least two entities included in the expertise information of the candidate object, and an average of the at least two object sub-feature representations may be used as the candidate object feature representation. For example, the word2vec model may be employed as the unsupervised vector generation model, and the expertise information of the candidate object may include two entities, such as “cold” and “fever”. Vectors [0.4, 0.1] and [0.7, 0.5] may be generated by the word2vec model, and the average [0.55, 0.3] of the two vectors may be calculated and determined as the candidate object feature representation.

In general, a large number of entities may be included in the description information of the user request and a large number of entities may be included in the expertise information of the candidate object. Therefore, the calculation amount is large when calculating the responsivity subsequently based on the user feature representation and the candidate object feature representation. Since the target object is recommended to the user, a priority of the user feature representation is higher than a priority of the candidate object feature representation. Therefore, by averaging the at least two object sub-feature representations as the candidate object feature representation, a calculation amount may be reduced while accurately recommending the target object to the user. In another example, based on the unsupervised vector generation model, the at least two object sub-feature representations may be generated based on the at least two entities included in the expertise information of the candidate object, and the at least two object sub-feature representations may be used as the candidate object feature representation.

In an example, after the user feature representation and the candidate object feature representation are generated, with the unsupervised vector generation model, respectively based on the entities included in the description information of the user request and the entities included in the expertise information of the candidate object, the method may further include establishing an index between the user feature representation and the candidate object feature representation, and saving the index in a feature representation database.

By calculating and saving the user feature representation and the candidate object feature representation based on the unsupervised vector generation model, a data support is provided for subsequent determining the responsivity of the candidate object to the user. In addition, the feature representation may be calculated based on the unsupervised vector generation model without sample tags, which may be applied to a field where it is unable to acquire high-quality tags.

At block S203, the at least two user sub-feature representations of the user feature representation and at least two sub-responsivities of the candidate object feature representation are determined respectively.

In detail, the user feature representation and the candidate object feature representation may be considered as two groups of multi-dimensional input signals, and may be inputted to a mode response system including a response function. For example, the response function may include, but not limited to, a cosine distance, a Euclidean distance, a convolution function, a Markov distance, and a metric function based on a neural network. In a case where the response function is the cosine distance, the user feature representation is (0.5, 0.5) and (0.1, 0.1), the candidate object feature representation is (0.1, 0.2). The two sub-responsivities may be calculated as

$$\frac{0.5 \times 0.1 + 0.5 \times 0.2}{\sqrt{{0.5}^{2} + {0.5}^{2}} \times \sqrt{{0.1}^{2} + {0.2}^{2}}} = 0.94 and$$

$$\frac{0.1 \times 0.1 + 0.1 \times 0.2}{\sqrt{{0.1}^{2} + {0.1}^{2}} \times \sqrt{{0.1}^{2} + {0.2}^{2}}} = 0.96 .$$

At block S204, the responsivity of the candidate object to the user is determined based on the at least two sub-responsivities.

In detail, a higher one of the at least two sub-responsivities may be determined as the responsivity of the candidate object to the user.

At block S205, the target object is selected for the user from the candidate object based on the responsivity of the candidate object of the user.

With the technical solution according to embodiments of the present disclosure, based on the unsupervised vector generation model, the user feature representation is generated based on the entity included in the description information of the user request and the candidate object feature representation is generated based on the entity included in the expertise information of the candidate object, to convert the entities into the distributed semantic representations, such as the vectors, without a large amount of manual annotations. The at least two sub-responsivities of the user feature representation and the candidate object feature representation are determined, and the responsivity of the candidate object to the user is determined based on the at least two sub-responsivities, thereby realizing to accurately determine a perfect candidate object and achieving high stability of the object recommendation.

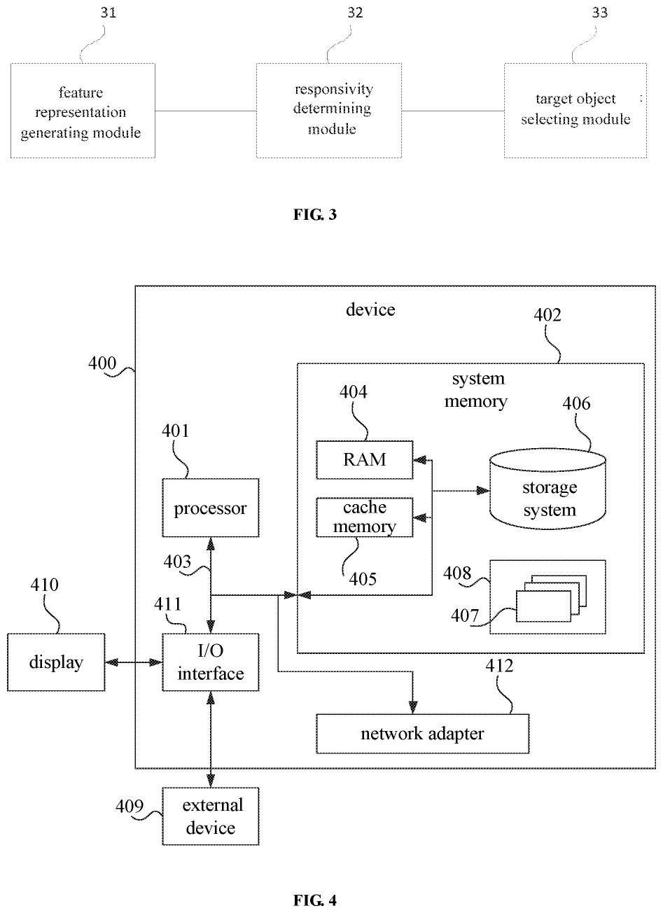

FIG. 3 is a block diagram illustrating an apparatus for intelligently recommending an object according to embodiments of the present disclosure. The apparatus may be configured to execute the method for intelligently recommending an object described above, and have functional modules and beneficial effects corresponding to the method. As illustrated in FIG. 3, the apparatus may include: a feature representation generating module 31, a responsivity determining module 32, and a target object selecting module 33.

The feature representation generating module 31 may be configured to generate a user feature representation based on description information of a user request and generate a candidate object feature representation based on expertise information of a candidate object.

The responsivity determining module 32 may be configured to determine a responsivity of the candidate object to a user based on the user feature representation and the candidate object feature representation.

The target object selecting module 33 may be configured to select a target object for the user from candidate objects based on responsivities of candidate objects to the user.

In an example, the feature representation generating module may include an entity determining unit and a feature representation generating unit.

The entity determining unit may be configured to determine an entity included in the description information of the user request and determine an entity included in the expertise information of the candidate object.

The feature representation generating unit may be configured to, with an unsupervised vector generation model, generate the user feature representation based on the entity included in the description information of the user request and generate the candidate object feature representation based on the entity included in the expertise information of the candidate object.

In an example, the entity determining unit may include a word segmentation sub-unit and an entity obtaining sub-unit.

The word segmentation sub-unit may be configured to perform word segmentation on the description information of the user request and on the expertise information of the candidate object respectively according to entities in a knowledge graph of a field of the candidate object.

The entity obtaining sub-unit may be configured to input resultant word segments of the description information of the user request and the expertise information of the candidate object into a depth learning network model, to obtain the entity included in the description information of the user request and the entity included in the expertise information of the candidate object. The depth learning network model may include a bidirectional long short-term memory network layer, an attention mechanism layer, and a conditional random field layer.

In an example, the feature representation generating module 31 may further include a vector generation model constructing unit, arranged before the feature representation generating unit and configured to use literatures of the field of the candidate object as a corpus, to construct the unsupervised vector generation model.

In an example, the feature representation generating unit 31 may include a user feature representation determining sub-unit and a candidate object feature representation determining sub-unit.

The user feature representation determining sub-unit may be configured to, with the unsupervised vector generation model, generate at least two user sub-feature representations based on at least two entities included in the description information of the user request as the user feature representation.

The candidate object feature representation determining sub-unit may be configured to, with the unsupervised vector generation model, generate at least two object sub-feature representations based on at least two entities included in the expertise information of the candidate object and average the at least two object sub-feature representations as the candidate object feature representation.

In an example, the responsivity determining module 32 may include a sub-responsivity determining unit and a responsivity determining unit.

The sub-responsivity determining unit may be configured to determine at least two user sub-feature representations of the user feature representation and at least two sub-responsivities of the candidate object feature representation.

The responsivity determining unit may be configured to determine the responsivity of the candidate object to the user based on the at least two sub-responsivities.

The apparatus for intelligently recommending an object according to embodiments of the present disclosure may execute the method for intelligently recommending the object described above, and has functional modules and beneficial effects corresponding to the method. Technical details not described in detail here may refer to the method for intelligently recommending an object described above.

FIG. 4 is a block diagram illustrating a device according to embodiments of the present disclosure. An exemplary device 400 illustrated in FIG. 4 is capable to implement the present disclosure. The device 400 illustrated in FIG. 4 is only an example, which is not used to limit functions and scope of the present disclosure.

As illustrated in FIG. 4, the device 400 is embodied in the form of a general-purpose computer device. Components of the device 400 may include but not limited to: one or more processors or processing units 401, a system memory 402, and a bus 403 connecting different system components (including the system memory 402 and the processing unit 401).

The bus 403 represents one or more of several bus structures, including a storage bus or a storage controller, a peripheral bus, an accelerated graphics port and a processor or a local bus with any bus structure in the plurality of bus structures. For example, these architectures include but not limited to an industry standard architecture (ISA) bus, a micro channel architecture (MAC) bus, an enhanced ISA bus, a video electronics standards association (VESA) local bus and a peripheral component interconnection (PCI) bus.

The device 400 typically includes various computer system readable mediums. These mediums may be any usable medium that may be accessed by the device 400, including volatile and non-volatile mediums, removable and non-removable mediums.

The system memory 402 may include computer system readable mediums in the form of volatile medium, such as a random-access memory (RAM) 404 and/or a cache memory 405. The device 400 may further include other removable/non-removable, volatile/non-volatile computer system storage mediums. Only as an example, the storage system 406 may be configured to read from and write to non-removable, non-volatile magnetic mediums (not illustrated in FIG. 4, which is usually called “a hard disk driver”). Although not illustrated in FIG. 4, a magnetic disk driver configured to read from and write to the removable non-volatile magnetic disc (such as “a diskette”), and an optical disc driver configured to read from and write to a removable non-volatile optical disc (such as a CD-ROM, a DVD-ROM or other optical mediums) may be provided. Under these circumstances, each driver may be connected with the bus 403 by one or more data medium interfaces. The system memory 402 may include at least one program product. The program product has a set of program modules (such as, at least one program module), and these program modules are configured to execute functions of respective embodiments of the present disclosure.

A program/utility tool 408, having a set (at least one) of program modules 407, may be stored in the system memory 402. Such program modules 407 include but not limited to an operating system, one or more application programs, other program modules, and program data. Each or any combination of these examples may include an implementation of a networking environment. The program module 407 usually executes functions and/or methods described in embodiments of the present disclosure.

The device 400 may communicate with one or more external devices 409 (such as a keyboard, a pointing device, and a display 410), may further communicate with one or more devices enabling a user to interact with the device 400, and/or may communicate with any device (such as a network card, and a modem) enabling the device 400 to communicate with one or more other computing devices. Such communication may occur via an Input/Output (I/O) interface 411. Moreover, the device 400 may further communicate with one or more networks (such as local area network (LAN), wide area network (WAN) and/or public network, such as Internet) via a network adapter 412. As illustrated in FIG. 4, the network adapter 412 communicates with other modules of the device 400 via the bus 403. It should be understood that, although not illustrated in FIG. 4, other hardware and/or software modules may be used in combination with the device 400, including but not limited to: microcode, device drivers, redundant processing units, external disk drive arrays, RAID (redundant array of independent disks) systems, tape drives, and data backup storage systems, etc.

The processor 401, by operating programs stored in the system memory 402, executes various function applications and data processing, for example implements the method for intelligently recommending an object according to embodiments of the present disclosure. The method may include generating a user feature representation based on description information of a user request and generating a candidate object feature representation based on expertise information of a candidate object; determining a responsivity of the candidate object to the user based on the user feature representation and the candidate object feature representation; and selecting a target object for the user from candidate objects based on responsivities of the candidate objects to the user.

Embodiments of the present disclosure further provide a computer readable storage medium. A method for intelligently recommending an object is executed when the computer executable instructions are executed by a processor of a computer. The method may include generating a user feature representation based on description information of a user request and generate a candidate object feature representation based on expertise information of a candidate object; determining a responsivity of the candidate object to the user based on the user feature representation and the candidate object feature representation; and selecting a target object for the user from candidate objects based on responsivities of the candidate objects to the user.

Embodiments of the present disclosure provide a storage medium including the computer executable instructions. The computer executable instructions are not limited to the above method, and may also perform related operations in a method for recommending an intelligent object according to any one of embodiments of the present disclosure. The computer storage medium in embodiments of the present disclosure may employ any combination of one or more computer readable mediums. The computer readable medium may be a computer readable signal medium or a computer readable storage medium. The computer readable storage medium may be, for example, but not limited to an electronic, magnetic, optical, electromagnetic, infrared, or semiconductor system, apparatus or device, or any suitable combination of the foregoing. More specific examples (a non-exhaustive list) of the computer readable storage medium may include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical memory device, a magnetic memory device, or any appropriate combination of the foregoing. In this document, the computer readable storage medium can be any tangible medium that contains or stores a program. The program can be used by or in conjunction with an instruction execution system, apparatus or device.

The computer readable signal medium may include a data signal transmitted in the baseband or as part of a carrier, in which computer readable program codes are carried. The transmitted data signal may employ a plurality of forms, including but not limited to an electromagnetic signal, a light signal or any suitable combination thereof. The computer readable signal medium may also be any computer readable medium other than the computer readable storage medium. The computer readable medium may send, propagate or transmit programs configured to be used by or in combination with an instruction execution system, apparatus or device.

The program codes included in the computer readable medium may be transmitted by any appropriate medium, including but not limited to wireless, electric wire, optical cable, RF (Radio Frequency), or any suitable combination of the foregoing.

The computer program codes for executing operations of the present disclosure may be programmed using one or more programming languages or the combination thereof. The programming languages include object-oriented programming languages, such as Java, Smalltalk, C++, and also include conventional procedural programming languages, such as the C programming language or similar programming languages. The program codes may be executed entirely on a user computer, partly on the user computer, as a stand-alone software package, partly on the user computer and partly on a remote computer, or entirely on the remote computer or server. In the scenario involving the remote computer, the remote computer may be connected to the user computer through any type of network, including a local area network (LAN) or a wide area network (WAN), or may be connected to an external computer (for example, through the Internet using an Internet service provider).

The above is only an optimal embodiment of the present disclosure and technical principle applied thereto. It should be understood by the skilled in the art that, the present disclosure is not limited to the specific embodiment described herein. The skilled in the art may make various obvious changes, modifications and alternatives without departing from the scope of the present disclosure. Therefore, although a detailed illumination is made to the present disclosure by the above embodiments, the present disclosure is not merely limited to the above embodiments. More other equivalent embodiments may also be included without departing from the technical idea of the present disclosure. The scope of the present disclosure is determined by the appended claims.

What is claimed is:

1. A method for intelligently recommending an object, comprising:
generating a user feature representation based on description information of a user request and a candidate object feature representation based on expertise information of a candidate object;
determining a responsivity of the candidate object to the user based on the user feature representation and the candidate object feature representation; and
selecting a target object for the user from candidate objects based on responsivities of the candidate objects to the user.

2. The method of claim 1, wherein generating the user feature representation based on the description information of the user request and the candidate object feature representation based on the expertise information of the candidate object comprises:
determining an entity comprised in the description information of the user request and an entity comprised in the expertise information of the candidate object; and
with an unsupervised vector generation model, generating the user feature representation based on the entity comprised in the description information of the user request and the candidate object feature representation based on the entity comprised in the expertise information of the candidate object.

3. The method of claim 2, wherein, determining the entity comprised in the description information of the user request and the entity comprised in the expertise information of the candidate object comprises:
performing word segmentation on the description information of the user request and the expertise information of the candidate object respectively based on entities in a knowledge graph of a field of the candidate object; and
inputting resultant word segments of the description information of the user request and the expertise information of the candidate object into a depth learning network model, to obtain the entity comprised in the description information of the user request and the entity comprised in the expertise information of the candidate object, wherein the depth learning network model comprises a bidirectional long-short term memory network layer, an attention mechanism layer, and a conditional random field layer.

4. The method of claim 2, wherein the method further comprises:
using literatures of a field of the candidate object as a corpus, to construct the unsupervised vector generation model.

5. The method of claim 2, wherein, with the unsupervised vector generation model, generating the user feature representation based on the entity comprised in the description information of the user request and the candidate object feature representation based on the entity comprised in the expertise information of the candidate object comprises:
with the unsupervised vector generation model, generating at least two user sub-feature representations based on at least two entities comprised in the description information of the user request as the user feature representation; and
with the unsupervised vector generation model, generating at least two object sub-feature representations based on at least two entities comprised in the expertise information of the candidate object; and averaging the at least two object sub-feature representations as the candidate object feature representation.

6. The method of claim 1, wherein, determining the responsivity of the candidate object to the user based on the user feature representation and the candidate object feature representation comprises:
determining the at least two user sub-feature representations in the user feature representation and at least two sub-responsivities in the candidate object feature representation; and
determining the responsivity of the candidate object to the user based on the at least two sub-responsivities.

7. A device, comprising:
one or more processors; and
a storage device, configured to store one or more programs,
wherein, when the one or more programs are executed by the one or more processors, the one or more processors are configured to:
generate a user feature representation based on description information of a user request and a candidate object feature representation based on expertise information of a candidate object;
determine a responsivity of the candidate object to the user based on the user feature representation and the candidate object feature representation; and
select a target object for the user from candidate objects based on responsivities of the candidate objects to the user.

8. The device of claim 7, wherein the one or more processors are further configured to generate the user feature representation based on the description information of the user request and the candidate object feature representation based on the expertise information of the candidate object by:
determining an entity comprised in the description information of the user request and an entity comprised in the expertise information of the candidate object; and
with an unsupervised vector generation model, generating the user feature representation based on the entity comprised in the description information of the user request and the candidate object feature representation based on the entity comprised in the expertise information of the candidate object

9. The device of claim 8, wherein the one or more processors are configured to determine the entity comprised in the description information of the user request and the entity comprised in the expertise information of the candidate object by:
performing word segmentation on the description information of the user request and the expertise information of the candidate object respectively based on entities in a knowledge graph of a field of the candidate object; and
inputting resultant word segments of the description information of the user request and the expertise information of the candidate object into a depth learning network model, to obtain the entity comprised in the description information of the user request and the entity comprised in the expertise information of the candidate object, wherein the depth learning network model comprises a bidirectional long-short term memory network layer, an attention mechanism layer, and a conditional random field layer.

10. The device of claim 8, wherein the one or more processors are further configured to:
use literatures of a field of the candidate object as a corpus, to construct the unsupervised vector generation model.

11. The device of claim 8, wherein the one or more processors are configured to, with the unsupervised vector generation model, generate the user feature representation based on the entity comprised in the description information of the user request and the candidate object feature representation based on the entity comprised in the expertise information of the candidate object by:
with the unsupervised vector generation model, generating at least two user sub-feature representations based on at least two entities comprised in the description information of the user request as the user feature representation; and
with the unsupervised vector generation model, generating at least two object sub-feature representations based on at least two entities comprised in the expertise information of the candidate object; and averaging the at least two object sub-feature representations as the candidate object feature representation.

12. The device of claim 7, wherein the one or more processors are configured to determine the responsivity of the candidate object to the user based on the user feature representation and the candidate object feature representation by:
determining the at least two user sub-feature representations in the user feature representation and at least two sub-responsivities in the candidate object feature representation; and
determining the responsivity of the candidate object to the user based on the at least two sub-responsivities.

13. A non-transitory computer readable storage medium, having a computer program stored thereon, wherein, when the computer program is executed by a processor, a method for intelligently recommending an object, the method comprising:
generating a user feature representation based on description information of a user request and a candidate object feature representation based on expertise information of a candidate object;
determining a responsivity of the candidate object to the user based on the user feature representation and the candidate object feature representation; and
selecting a target object for the user from candidate objects based on responsivities of the candidate objects to the user.

14. The non-transitory computer readable storage medium of claim 13, wherein generating the user feature representation based on the description information of the user request and the candidate object feature representation based on the expertise information of the candidate object comprises:
determining an entity comprised in the description information of the user request and an entity comprised in the expertise information of the candidate object; and
with an unsupervised vector generation model, generating the user feature representation based on the entity comprised in the description information of the user request and the candidate object feature representation based on the entity comprised in the expertise information of the candidate object.

15. The non-transitory computer readable storage medium of claim 14, wherein, determining the entity comprised in the description information of the user request and the entity comprised in the expertise information of the candidate object comprises:
performing word segmentation on the description information of the user request and the expertise information of the candidate object respectively based on entities in a knowledge graph of a field of the candidate object; and
inputting resultant word segments of the description information of the user request and the expertise information of the candidate object into a depth learning network model, to obtain the entity comprised in the description information of the user request and the entity comprised in the expertise information of the candidate object, wherein the depth learning network model comprises a bidirectional long-short term memory network layer, an attention mechanism layer, and a conditional random field layer.

16. The non-transitory computer readable storage medium of claim 14, wherein the method further comprises:
using literatures of a field of the candidate object as a corpus, to construct the unsupervised vector generation model.

17. The non-transitory computer readable storage medium of claim 14, wherein, with the unsupervised vector generation model, generating the user feature representation based on the entity comprised in the description information of the user request and the candidate object feature representation based on the entity comprised in the expertise information of the candidate object comprises:
with the unsupervised vector generation model, generating at least two user sub-feature representations based on at least two entities comprised in the description information of the user request as the user feature representation; and
with the unsupervised vector generation model, generating at least two object sub-feature representations based on at least two entities comprised in the expertise information of the candidate object; and averaging the at least two object sub-feature representations as the candidate object feature representation.

18. The non-transitory computer readable storage medium of claim 13, wherein, determining the responsivity of the candidate object to the user based on the user feature representation and the candidate object feature representation comprises:
determining the at least two user sub-feature representations in the user feature representation and at least two sub-responsivities in the candidate object feature representation; and
determining the responsivity of the candidate object to the user based on the at least two sub-responsivities.
